(19) United States
(12) Patent Application Publication
(10) Pub. No.: US 2011/0200803 A1
(43) Pub. Date: Aug. 18, 2011

(54) Self-Primed Coating Formulation and Universal, Printable, Plastic Media Coated with the Formulation

(76) Inventor: Jieming Li, Bayside, WI (US)

(21) Appl. No.: 12/705,724

(22) Filed: Feb. 15, 2010

(51) Int. Cl. B32B 3/10; B32B 27/40; B32B 5/16; C08L 75/04; C08K 3/22; C08K 3/10; C08K 3/26; C08K 3/34

(52) U.S. Cl. 428/207; 428/423.1; 428/328; 428/330; 428/323; 524/589; 524/430; 524/437; 524/425; 524/447; 524/445; 524/451; 524/413; 524/432

(57) ABSTRACT

Self-primed, printable formulations comprise:
A. A polyurethane binder,
B. An absorptive pigment,
C. A crosslinker,
D. An ultraviolet (UV) absorber,
E. A light stabilizer, and
F. Solvent.
   These formulations are coated to plastic substrates without the substrate first receiving a primer coating or other surface treatment to enhance print receptivity. These coatings provide a high performance, single layer, matte-finish, universal printable plastic media for use with a wide variety of printers and photocopiers. In one embodiment the single layer matte finish universal printable media is converted to a satin finish universal printable media by applying a gloss-promoting coating formulation over the single layer matte finish base layer.

### FIELD OF THE INVENTION

This invention relates to coating formulations. In one aspect the invention relates to printable coating formulations while in another aspect, the invention relates to printable coating formulations that can be applied to a wide variety of plastic substrates without the need for a primer. In yet another aspect the invention relates to printable media coated with the formulation. In still another aspect the invention relates to durable, printed media in which the media is coated with the universal, printable formulation prior to printing.

### BACKGROUND OF THE INVENTION

Untreated plastic film substrates, e.g., polyester, vinyl, nylon cloth, polyethylene, polypropylene, polyimide and the like, are non-absorbent and as such, they are not amenable to receiving and holding print from a thermal transfer printer, inkjet printer, dot matrix printer, laser printer, photocopier, etc. To render these substrates printable, they are typically coated on one side with a formulation that is receptive to the ink/toner with which they will be printed. However, different formulations are typically required for different inks/toners. In other words, a formulation that will receive and hold print from a thermal transfer printer may not receive and hold ink from a laser printer, or a formulation that will receive and hold print from a dot matrix printer may not receive and hold print from a photocopier.

Complicating matters is that in order for the coating formulation to properly adhere to the plastic substrate, typically the substrate must first receive a primer coating, e.g., a coating that will tie the formulation designed to receive and hold the print to the underlying plastic substrate, and different primers are typically required for different substrates. Primers that are effective for polyester substrates may not be effective for vinyl, nylon cloth, polyolefin and/or polyimide.

As such, current printing technology for plastic substrates requires not only designing a coating formulation for a particular type of printer or copier ink, but also designing a primer for a particular plastic substrate. These inefficiencies are best addressed by designing a self-primed coating formulation that will receive and hold print from virtually any type of printer, copier or other device that delivers ink or other print vehicle to a plastic substrate.

### SUMMARY OF THE INVENTION

In one embodiment the invention is a printable, self-primed coating formulation for plastic substrates. In one embodiment the invention is a plastic substrate coated with the printable, self-primed formulation. In one embodiment the invention is a durable, printed plastic media in which the media comprises a printable, self-primed coating formulation on at least one of its facial surfaces. The coating formulation imparts universal printability, high performance and a matte-finish in a single layer to the plastic media so that it can be used with a wide variety of printers and copiers. Graphic images imparted by printing, photocopying, etc. to plastic media coated with the self-primed formulation of this invention exhibit good durability against abrasion, solvents, humidity, heat aging and weathering.

In one embodiment the invention provides a gloss-promoting coating formulation which converts a single layer matte finish universal printable media to a satin finish universal printable media by applying the gloss-promoting coating formulation over the single layer matte finish base layer. The coated satin finish universal printable media are suitable to print text, images, bar codes and the like with thermal transfer printer, inkjet printer, dot matrix printer, laser printer, photocopier and the like.

In one embodiment the invention is a coating formulation comprising:
A. A polyurethane binder,
B. An absorptive pigment,
C. A crosslinker,
D. An ultraviolet (UV) absorber,
E. A light stabilizer, and
F. Solvent.
   The UV absorber and light stabilizer are typically paired and used in combination with one another and the combination of UV absorber, light stabilizer and crosslinker impart good durability to graphic images imparted to the coated media. The combination of polyurethane binder and absorptive pigment impart good printability to the coated media. The coating formulation is self-primed which allows it to be applied to a wide variety of substrates, particularly plastic substrates, without the substrate first receiving a primer layer or other surface treatment. The formulation is typically applied as a single layer coating to the plastic media using any conventional coating technique, e.g., wire wound rod, reverse roll, slot die, gravure, spraying, dipping, etc. The plastic media coated with the formulation can be printed or otherwise marked with graphic images on a wide variety of printers and photocopiers, and the graphic images exhibit good durability against abrasion, solvents, humidity, heat aging and weathering.

In one embodiment the invention is coated, plastic media comprising opposing facial surfaces, neither facial surface comprising a primer or having received a surface treatment prior to application of the coating, the coating comprising:
A. A polyurethane binder,
B. An absorptive pigment,
C. A crosslinker,
D. An ultraviolet (UV) absorber,
E. A light stabilizer, and
F. Solvent.

In one embodiment the invention is a coated, plastic media as described above in which the coating further comprises a durable graphic image received from at least one of a thermal transfer printer, inkjet printer, dot matrix printer, laser printer or photocopier.

### DETAILED DESCRIPTION OF THE PREFERRED EMBODIMENT

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, concentration, thickness, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the relative amounts of components in the formulation.

“Formulation”, “composition” and like terms means a mixture or blend of two or more components. In the context of the inventive formulations of this invention, the mixture or blend of materials include a polyurethane binder, absorptive pigment, crosslinker, UV-absorber, light stabilizer, solvent and, optionally, one or more fillers or additives.

“Facial surface” and like terms are used in distinction to “edge surface”. If rectangular in shape or configuration, a film will comprise two opposing facial surfaces joined by four edge surfaces (two opposing pairs of edge surfaces, each pair intersecting the other pair at right angles). If circular in configuration, then the film will comprise two opposing planar surfaces joined by one continuous edge surface.

“Graphic image” and like terms mean text or pictorial representations formed of ink or other dye or pigment substances. Graphic images include, but are not limited to, words, numbers, bar codes, pictures, designs (geometric or otherwise), and solid colors.

“Ink” and like terms mean a coatable or printable formulation that can and usually does contain a dye and/or pigment.

“Dye” and like terms mean a visible light absorbing compound that is present in a molecularly dispersed (dissolved) form.

“Pigment” and like terms mean a visible light absorbing material or compound that is present in a non-molecularly dispersed (particulate) form.

“Plastic media” and like terms mean structures comprising plastic and opposing facial surfaces. These structures are typically film or cloth of appropriate size and shape so that they can be fed to a conventional thermal transfer printer, dot matrix printer, inkjet printer, laser printer or photocopier to receive a graphic image.

“Printable” and like terms mean that a substrate will receive and hold a graphic image comprising ink, dye and/or pigment delivered from a printer or copier.

“Self-primed” and like terms as used to describe a coating formulation mean that the formulation comprises will adhere to a facial surface of plastic media the facial surface first receiving a primer or surface treatment, e.g., corona, plasma, mechanical etching or the like.

“Universal printable media” and like terms mean a plastic film substrate such as polyester, vinyl, nylon cloth, polyolefin (e.g., polyethylene, polypropylene, etc.), polyimide and the like coated with a formulation comprising a polyurethane binder, an adsorptive pigment, a crosslinker, a UV absorber and/or light stabilizer, and a solvent. Typically and preferably the plastic substrate is coated directly, i.e., without any intermediate layer (e.g., a primer) between the substrate and the formulation coating, with single layer of the formulation, and the formulation comprises both a UV absorber and a light stabilizer.

While the coating formulation can be applied to any substrate (plastic, paper or other, whether primed or otherwise surface treated or not), the coating formulations of this invention are particularly well suited for direct application to non-primed or otherwise non-surface treated, non-absorbent substrates, particularly plastic substrates such as polyester, vinyl, nylon (film or cloth), polyolefin (e.g., polyethylene, polypropylene), polyimide and the like. With the application of the coating formulation of this invention, these otherwise non-absorbent media are available for efficient, effective and durable printing by a wide variety of methods using a wide variety of standard printers and copiers, e.g., thermal transfer printers, inkjet printers, dot matrix printers, laser printers, photocopiers and the like. Print methods include flexography, offset, screen printing and the like.

The coating formulation can be applied to the media in any manner, e.g., wire wound rod, reverse roll, slot die, gravure, spraying, dipping, etc., and application of the coating is usually, but not necessarily, followed by a heat drying/curing process, e.g., exposure to a temperature of 50 to 200° C. for 1 to 10 minutes depending on the type of substrate and the desired performance of the coated media such as chemical/solvent resistance, scratch/abrasion resistance, durability, etc. The coating formulation is typically applied at a thickness of 5 to 200, more typically 10 to 100 and even more typically 20 to 50, micrometers (μm). The coating formulation is typically applied as a single layer, and it provides a matte finish for the print. The coating is receptive, retentive and protective of most, if not all, inks and other colorants conventionally used in the variety of printers and photocopiers described above.

Typically the polyurethane binder is used in the range of 5 to 80, more typically in the range of 10 to 60 and even more typically in the range of 15 to 40, percent by weight (wt %), based on the total weight of solids in the formulation. The polyurethane binder typically has multiple urethane groups (—NHCOO) in its main chain. Typically it is based on aliphatic or cycloaliphatic polyisocyanates to improve light stability. It also contains high or low molecular weight compounds having active hydroxyl groups or amino groups. The high molecular weight compounds include polyester diols, polyether diols, and polycarbonate diols. The low molecular weight compounds include glycol such as ethylene glycol, 1,4-butanediol, and 1,6 hexane diol and diamine, for example, isopropyl diamine and hexamethylene diamine. This polyurethane binder is typically soft/flexible with a glass transition temperature (Tg) at or below 0° C., and it is typically available as a crosslinkable, hydrophilic, water dispersion, such as, without limitation, WITCOBOND W-213, W-232, W-234, W-236, W-240, W-505, W-506, W-507, W-736, W-170, W-281F, W-296 and W-320 all available from Chemtura Shanghai Co. Ltd.; SANCURE 815, 1301, 20025, and 12929 all available from Lubrizol; and BAYBOND PU 445 and PU 685 available from Bayer MaterialScience. The binder functions as a (1) binder for the absorptive pigment particles, (2) primer for the coating formulation for adhesion promotion on the substrate, (3) film-forming agent on the substrate, and (4) affinity of the printed inks.

Typically the absorptive pigment is used in the range of 10 to 80, more typically in the range of 15 to 60 and even more typically in the range of 25 to 45, wt % based on total weight of solids in the formulation. The absorptive pigment is typically available as a hydrophilic, microporous, absorptive silica, alumina, boehmite, calcium carbonate, kaolin, clay, talc, titanium dioxide, zinc oxide and the like. Typically and preferably the absorptive pigments used in the practice of this invention have a large absorption capacity, as is commonly defined by their oil absorption value. Typically the pigment has an oil absorption value greater than 100, more typically greater than 200, and even more typically greater than 300, milliliters of oil per 100 grams of pigment particles (ml/100 g). In one embodiment the oil absorption value correlates to a specific pore volume of at least 0.5, more preferably at least 1, even more preferably at least 1.5, ml/g. Generally, the higher the oil absorption, the better the performance of the pigment. The method for measuring the oil absorption value is set forth in ASTM D281-31.

In one embodiment the pigments used in the practice of this invention have an average particle size with a narrow particle size distribution, e.g., an average particle size of 1 to 25, more typically of 2 to 12 and even more typically of 3 to 7, microns (μm). Typical absorptive pigments for this invention include SYLOID C803, C805, C807, C809, C812, and C816 all available from W. R. Grace & Co.; GASIL 35M, P101, 23D, 23F, HP39, and HP395 all available from Ineos; and SYLYSIA 310P, 320, 350, 370, 380, 420, 430, 440, 450, 470, 530, and 550 all available from Fuji Sylysia Chemical Ltd.

Typically the crosslinker is used in the range of 5 to 60, more typically in the range of 15 to 50 and even more typically in the range of 25 to 45, wt % based on total weight of solids in the formulation. The function of the crosslinker is to tie the pigment and binder together to form a network for solvent resistance and mechanical strength enhancement of the coated media after cure. The crosslinker is typically heat curable, and typical crosslinkers include CYMEL 385, 323, 328, 350, 373, 1171, 1172, 9370, U60 and UM-15 all available from Cytec Industries; RESIMENE 717 available from Ineos; polyfunctional aziridine crosslinker XAMA-7 available from Bayer Material Science; and polyfunctional isocyanates based BASONAT HW-100 available from BASF.

The UV absorbers are typically compounds classified as derivatives of hydroxybenzotrizole, hydroxybenzophenone and triazines, such as hydroxyphenol-s-triazines. Representative UV absorbers include TINUVIN 1130, 384, 928, 400 and 477-DW all available from Ciba (now a part of BASF). Light stabilizers are typically hindered amine light stabilizers (HALS). Representative light absorbers include the HALS light absorbers TINUVIN 123, 144 and 292 and CHIMASSORB 944 also available from Ciba. Although the coating formulations of this invention can comprise the UV absorber or light stabilizer in the absence of the other, typically and preferably the UV absorber and light stabilizer are used in combination with one another, and the combination of the two are typically used in the range of 0.5 to 10, more typically in the range of 1 to 8 and even more typically in the range of 2 to 6, wt % based on total weight of solids in the formulation. The UV absorber and light stabilizer are typically used at a UV absorber to light stabilizer ratio of 1:10 to 10:1, more typically of 1:5 to 5:1 and even more typically of 1:2 to 4:1, by weight. The use of a combination of UV absorber and light stabilizer extends the durability and weatherability of the coated media. Crosslinked polyurethane based porous media when stabilized with a package of UV absorber and light stabilizer have proven especially suitable for applications requiring outdoor weatherability.

The solvent of the coating formulation is a mixture of de-ionized water with one or more alcohols with the alcohol content in the mixture not less than 50% by weight. Due to the polar nature of the polyurethane binder, polar alcoholic solvent having a hydrocarbon moiety with at least one hydroxyl group are preferred. Suitable alcohols include hydrocarbon compounds having at least one carbon atom and at least one hydroxy group. They can have a wide range of carbon atoms and hydroxy groups. Preferably, however, the alcohol has less than 15 carbon atoms and less than 4 hydroxy groups. These alcohols may have other hetero atoms besides those contributed by the hydroxy group(s) that are primary, secondary or tertiary to the hydrocarbon moiety as their valence allows. Straight chain primary and secondary alcohols ranging from 1 to 6 carbon atoms in length, such as methanol, ethanol, n-propanol, isopropanol, n-butanol, isobutanol, and so forth, are preferred. Tertiary alcohols such as diacetone alcohol are also appropriate. Glycol ethers such as diethylene glycol monobutyl ether, ethylene glycol monobutyl ether and propylene glycol monomethyl ether (1-methoxy-2-propanol) may also be used. The solvent provides the coating formulation with the desired viscosity typically in the range of 10 to 5000, more typically in the range of 20 to 1000 and even more typically in the range of 50 to 500 centipoise (cps) as measured at 25° C. Typically the solvent is chosen so that the formulation flows easily onto the plastic media and then provides the coated media with the desired drying profile, especially when exposed to heat, e.g., 50 to 200° C., and/or vacuum, e.g., less than 0.1 Mega Pascals (MPa).

The solid content of the coating formulation can be adjusted based on the coating method and the desired thickness of the coated media. Typically the solid content is in the range of 5 to 50, more typically in the range of 10 to 40 and even more typically in the range of 20 to 35, percent by weight of the total weight of the coating formulation.

The coating formulation can be applied to the substrate in any manner, e.g., wire wound rod, reverse roll, slot die, gravure, spraying, dipping, etc., and application of the coating is usually followed by a heat drying/curing process, e.g., exposure to a temperature of 50 to 200° C. for 1 to 10 minutes, depending on the type of substrate and the desired performance of the coated media such as chemical/solvent resistance, scratch/abrasion resistance, durability, etc. The coating formulation is typically applied at a thickness of 5 to 200, more typically 10 to 100 and even more typically 20 to 50, microns (μm).

The coated media are single (usually and preferably) layer, matte finish universal printable media which are suitable for printing text, images, bar codes and the like with thermal transfer printers, inkjet printers, dot matrix printers, laser printers, photocopiers and the like. The coating is receptive and retentive of inks and other colorants conventionally used in the variety of printers and photocopiers described above. These universal printable media exhibit excellent printability, optical density, adhesion, scratch/abrasion resistance, chemical/solvent resistance, durability and weatherability.

In one embodiment the invention is a gloss-promoting coating formulation for making satin finish universal printable media. With the matte finish universal printable media as a base layer, satin finish universal printable media can be formed by applying a gloss-promoting coating formulation over the matte finish base layer. The gloss-promoting coating formulation comprises a mixture of a polyurethane binder, a nano/submicron-sized pigment, a combination of UV absorber and light stabilizer, a diluting agent of water, and a leveling/flow agent.

The polyurethane binder used in the gloss-promoting coating formulation is essentially the same as that used in the coating formulation for the universal printable media. Here the binder functions as a (1) binder for the nano/submicron-sized pigment particles, (2) adhesion promoter for the gloss-promoting layer to the base layer, (3) film-forming agent of the gloss-promoting coating formulation on the base layer, and (4) affinity of the printed inks. The amount of the polyurethane binder in the gloss-promoting coating formulation is correlated to the amount of the nano/submicron-sized pigment with a pigment to binder weight ratio typically in the range from 0.8:1 to 2:1, more typically from 1:1 to 1.5:1.

Typically the nano/submicron-sized pigment of the gloss-promoting coating formulation is water-dispersed nano/submicron-sized silica or alumina, and typically it has an average particle size of 30 to 400, more typically of 50 to 300 and even more typically of 80 to 200, nanometers (nm). When the average particle size of the nano/submicron-sized pigment is less than 30 nm, the gloss-promoting coating layer may have unsatisfactory ink-absorbing properties for inkjet printing due to the fact that the interstitial spaces or pores between such pigment particles may be too small, such that the ink cannot be effectively absorbed. When the average particle size of the pigment is greater than 400 nm, the gloss-promoting coating formulation may not be able provide satisfactory gloss due to light scattering issues. The nano/submicron-sized pigment is correlated with the polyurethane binder with a typical pigment to binder weight ratio of 0.8:1 to 2:1, more typically of 1:1 to 1.5:1. Representative nano/submicron-sized pigments of the gloss-promoting coating formulation of this invention include SYLOJET C30, 4000C, A25, and 710A all available from W. R. Grace & Co.; AERODISP W440, W630, WK341, WK7330, VP W7330N, VP Disp W925, VP Disp WK 7620, and VP Disp WK 7522 all available from Evonik; and AEROPAL 65, DISPAL 10F4, and DISPAL 1 1N7-80 all available from Sasol.

The UV absorber and light stabilizers used in the gloss-promoting coating formulation are essentially the same as used in the universal printable media formulation, and these are used in the same manner and amounts. Here too, typically and preferably the UV absorber and light stabilizer are used in combination with one another and in the same respective amounts.

Water, typically and preferably de-ionized water, is used as the diluting agent for the gloss-promoting coating formulation. It provides the desired viscosity for the formulation, typically in the range of 5 to 200, more typically in the range of 10 to 100 and even more typically in the range of 15 to 50 cps as measured at 25° C. De-ionized water is the diluting agent of choice because with it the gloss-promoting coating formulation flows easily onto the matte finish base layer and provides the coated media with the desired drying profile and satin finish with gloss in the range of 15-25 points as measured at 60 degrees.

The water based nature of the gloss-promoting coating formulation favors the use of a leveling/flow agent to provide the coating surfaces with a satisfactory flow-and-leveling properties and eliminate coating defects such as ruptures and craters. The leveling/flow agent, e.g., a surface active agent or surfactant, controls the wetting or spreading action of the coating formulation. Preferably, the leveling/flow agent of the gloss-promoting coating formulation for this invention is a non-ionic surfactant which is effective in aqueous media. Representative non-ionic surfactants which are suitable as leveling/flow agents for this invention include silicon-based surfactants and fluorocarbon surfactants. Examples of silicon-based surfactants are SILWET L-77, L-7200, L-7280, L-7600, L-7604, L7605, and L-7608 all available from Momentive Performance Materials; examples of fluorocarbon surfactants are FLUORAD FC-4430, FC-4432, and FC-4434 all available from 3M. The leveling/flow agents of the gloss-promoting coating formulation for this invention are typically used in the range of 0.05 to 1, more typically in the range of 0.1 to 0.8 and even more typically in the range of 0.2 to 0.6, wt % based on the weight of the total coating formulation.

The solid content of the gloss-promoting coating formulation can be adjusted based on the coating method and the desired thickness of the coated media. Typically the solid content is in the range of 5 to 30, preferably in the range of 10 to 20, percent by weight of the total weight of the coating formulation.

The gloss-promoting coating formulation can be applied to the substrate in any manner, e.g., wire wound rod, reverse roll, slot die, gravure, spraying, dipping, etc., and application of the coating is usually followed by a heat drying process, e.g., exposure to a temperature of 50 to 200° C. for 1 to 10 minutes, depending on the type of substrate. The coating formulation is typically applied at a thickness of 1 to 50, more typically 2 to 30 and even more typically 5 to 20, microns (μm).

The coated media are satin finish universal printable media which are suitable for printing text, images, bar codes and the like with thermal transfer printers, inkjet printers, dot matrix printers, laser printers, photocopiers and the like. The coating is receptive and retentive of inks and other colorants conventionally used in the variety of printers and photocopiers described above.

Both coating formulations described above, i.e., for matte finish universal printable media and gloss-promotion, typically generate white matte finish and white satin finish on a wide range of plastic film substrates, such as polyester, vinyl, nylon cloth, polyethylene, polypropylene, polyimide and the like for printing text, images, bar codes and the like with thermal transfer printer, inkjet printer, dot matrix printer, laser printer, photocopier and the like. Other colored pigments, additives and the like, such as yellow, red, green, blue, cyan, magenta, orange, golden, silver pigments, additives and the like can be formulated into the formulations and generate matte finish and satin finish universal printable media in yellow, red, green, blue, cyan, magenta, orange, golden, silver on the same range of plastic film substrates.

Universal printable media with higher gloss, e.g., with gloss of 40 points or more as measured at 60 degree, can be achieved by calendering the satin finish universal printable media. The calendering can be performed using a calendering apparatus such as a machine calender, a super calender or soft calender roll.

In addition to the above described printing methods of thermal transfer printer, inkjet printer, dot matrix printer, laser printer, photocopier and the like, the matte finish and satin finish universal printable media can also be applied to industrial printing technologies such as flexography, offset press, screen printing and the like.

The following experiments are provided to illustrate various embodiments of the invention. They are not intended to limit the invention as otherwise described and claimed. All numerical values arc approximate, and all parts and percentage are by weight unless otherwise indicated.

### Specific Embodiments

### UV Stabilizer Subformula UVS2

TABLE 1
Composition of UV Stabilizer Subformula UVS2

| Component | Source | Weight (g) |
|---|---|---|
| Isopropanol | Chemcentral | 80.00 |
| TINUVIN 1130 | Ciba | 13.33 |
| TINUVIN 123 | Ciba | 6.67 |
| Total | — | 100.00 |

UV Stabilizer Subformula UVS2 is compounded as follows;
1. Into a container add the desired amount of isopropanol.
2. While stirring, add the desired amount of TINUVIN 1130 and TINUVIN 123 to the container. Keep the container covered to minimize solvent losses.
3. Keep stirring until a homogeneous solution is formed.

### Coating Formulation 1356B2 for Matte Finish Universal Printable Media

TABLE 2
Composition of Coating Formulation B56B2

| Component | Source | Weight (g) | Solid Wt (g) | % Solid |
|---|---|---|---|---|
| De-ionized Water | — | 12.00 | — | — |
| n-Propanol | Chemcentral | 20.00 | — | — |
| 1-Methoxy-2-Propanol | Aldrich | 10.00 | — | — |
| Methanol | Chemcentral | 10.00 | — | — |
| SYLOID C803 Silica | W. R. Grace | 9.38 | 9.38 | 35.1 |
| WITCOBOND W-213 | Chemtura | 21.12 | 6.34 | 23.7 |
| CYMEL 385 | Cytec | 12.50 | 10.00 | 37.5 |
| UVS2 | — | 5.00 | 1.00 | 3.7 |
| Total | — | 100.00 | 26.72 | 100.0 |

Coating formulation B56B2 is compounded as follows:
1. Into a container add the desired amount of di-ionized water, n-propanol, 1-methoxy-2-propanol, and methanol. Start stirring.
2. Slowly add the desired amount of SYLOID silica C803 to the container while stirring. Stir for at least 2 hours after the last of the silica is added. Keep the container covered to minimize solvent losses.
3. Slowly add the desired amount of WITCOBOND, W-213 polyurethane dispersion to the container while stirring. Mix at least 1 hour before addition of CYMEL 385.
4. Slowly add the desired amount of CYMEL 385 to the container while stirring. Mix at least 1 hour before addition of UV Stabilizer Subformula UVS2.
5. Add the desired amount of previously prepared UV Stabilizer Subformula UVS2 to the container while stirring and keep stirring overnight.
6. Filter the coating with a 25-micron pocket filter.

### Gloss-Promoting Coating Formulation M56A for Satin Finish Universal Printable Media

TABLE 3
Composition of Gloss-Promoting Coating Formulation M56A

| | Source | Weight (g) | Solid Wt (g) | % Solid |
|---|---|---|---|---|
| De-ionized Water | — | 47.84 | — | — |
| AERODISP WK7330 | Evonik | 28.99 | 8.70 | 57.3 |
| WITCOBOND W-213 | Chemtura | 19.32 | 5.80 | 38.2 |
| UVS2 | — | 3.38 | 0.68 | 4.5 |
| SILWET L-77 | Momentive | 0.47 | — | — |
| Total | — | 100.00 | 15.18 | 100.0 |

Gloss-promoting coating formulation M56A is compounded as follows:
1. Into a container add the desired amount of de-ionized water. Start stirring.
2. Slowly add the desired amount of AERODISP WK7330 dispersion to the container while stirring. Stir for at least 1 hour after the last of the dispersion is added. Keep the container covered to minimize solvent losses.
3. Slowly add the desired amount of WITCOBOND W-2 13 polyurethane dispersion to the container while stirring. Mix at least 1 hour before addition of UV Stabilizer Subformula UVS2.
4. Add the desired amount of previously prepared UV Stabilizer Subformula UVS2 to the container while stirring. Mix at least 1 hour before addition of SILWET L-77.
5. Add the desired amount of SILWET L-77 to the container while stirring and keep stirring overnight.
6. Filter the coating via 25 micron pocket filter.
   Single Layer Matte Finish Universal Printable Media Coated with Coating Formulation B56B2

Cut corona-treated polyester, vinyl, nylon cloth, polyethylene, polypropylene and polyimide film substrates into 12″×18″ sections. Make drawdowns of coating formulation B56B2 on the corona treated side of the films using wire wound rod #40. Dry/cure the drawdowns in a convection oven with the desired temperatures and cure times as described in Table 4. The prepared media are single layer matte finish universal printable media which are suitable for printing text, images or bar codes with thermal transfer printer, inkjet printer, dot matrix printer, laser printer, photocopier, etc.

TABLE 4
Single Layer Matte Finish Universal Printable Media

| | Substrate | | | | |
|---|---|---|---|---|---|
| | | | | Polyolefin | |
| | | | Nylon | Polyethylene/ | |
| | Polyester | Vinyl | Cloth | Polypropylene | Polyimide |
| Coating | B56B2 | B56B2 | B56B2 | B56B2 | B56B2 |
| Formulation | | | | | |
| Coating | Wire wound | Wire wound | Wire wound | Wire wound | Wire wound |
| Method | rod #40 | rod #40 | rod #40 | rod #40 | rod #40 |
| Curing Temp | 170 | 70 | 120 | 120 | 170 |
| ° C. | | | | | |
| Curing Time | 5 | 5 | 5 | 5 | 5 |
| (min) | | | | | |
| Adhesion | Good | Good | Good | Good | Good |
| Scratch/ | Good | Good | Good | Good | Good |
| Abrasion | | | | | |
| Resistance | | | | | |
| Chemical/ | Good | Good | Good | Good | Good |
| Solvent | | | | | |
| Resistance | | | | | |
| Humidity | Good | Good | Good | Good | Good |
| Stability | | | | | |
| Heat Aging | Good | Good | Good | Good | Good |
| Stability | | | | | |
| Weathering | Good | Good | Good | Good | Good |
| Gloss | 2-3 | 2-3 | 2-3 | 2-3 | 2-3 |
| Thermal | Printable | Printable | Printable | Printable | Printable |
| Transfer | with gradeA | with grade A | with grade A | with grade A | with grade A |
| Printer | or B barcode | or B barcode | or B barcode | or B barcode | or B barcode |
| | readability | readability | readability | readability | readability |
| Inkjet Printer | Printable | Printable | Printable | Printable | Printable |
| | with optical | with optical | with optical | with optical | with optical |
| | density | density | density | density | density |
| | 1.1-1.3 | 1.1-1.3 | 1.1-1.3 | 1.1-1.3 | 1.1-1.3 |
| Dot Matrix | Printable | Printable | Printable | Printable | Printable |
| Printer | | | | | |
| Laser Printer | Printable | Printable | Printable | Printable | Printable |
| Photocopier | Printable | Printable | Printable | Printable | Printable |

Satin Finish Universal Printable Media Coated with Gloss-Promoting Coating Formulation M56A Over Base B56B2

With the polyester, vinyl, nylon cloth, polyethylene, polypropylene, and polyimide film substrates which are coated with coating formulation B56B2 as base, drawdowns are made of gloss-promoting coating formulation M56A over the base with wire wound rod #24. The drawdowns are dried in a convection oven with the desired temperatures and times as described in Table 5. The prepared media are satin finish universal printable media which are suitable to print text, images, bar codes and the like with thermal transfer printer, inkjet printer, dot matrix printer, laser printer, photocopier and the like.

TABLE 5
Satin Finish Universal Printable Media Coated with Gloss-
Promoting Coating Formulation M56A over Base B56B2

| | Substrate | | | | |
|---|---|---|---|---|---|
| | | | | Polyolefin | |
| | | | | Polyethylene/ | |
| | Polyester | Vinyl | Nylon Cloth | Polypropylene | Polyimide |
| Base | B56B2 | B56B2 | B56B2 | B56B2 | B56B2 |
| Coating | | | | | |
| Gloss- | M56A | M56A | M56A | M56A | M56A |
| Promoting | | | | | |
| Coating | | | | | |
| Coating | Wire wound | Wire wound | Wire wound | Wire wound | Wire wound |
| Method | rod #24 | rod #24 | rod #24 | rod #24 | rod #24 |
| Curing | 120 | 70 | 120 | 120 | 120 |
| Temp ° C. | | | | | |
| Curing | 5 | 5 | 5 | 5 | 5 |
| Time (min) | | | | | |
| Adhesion | Good | Good | Good | Good | Good |
| Scratch/ | Good | Good | Good | Good | Good |
| Abrasion | | | | | |
| Chemical/ | Good | Good | Good | Good | Good |
| Solvent | | | | | |
| Resistance | | | | | |
| Humidity | Good | Good | Good | Good | Good |
| Stability | | | | | |
| Heat Aging | Good | Good | Good | Good | Good |
| Stability | | | | | |
| Weathering | Good | Good | Good | Good | Good |
| Gloss | 15-25 | 15-25 | 15-25 | 15-25 | 15-25 |
| Thermal | Printable | Printable | Printable | Printable | Printable |
| Transfer | with grade A | with grade A | with grade A | with grade A | with grade A |
| Printer | or B barcode | or B barcode | or B barcode | or B barcode | or B barcode |
| | readability | readability | readability | readability | readability |
| Inkjet | Printable | Printable | Printable | Printable | Printable |
| Printer | with optical | with optical | with optical | with optical | with optical |
| | density | density | density | density | density |
| | 1.5-1.7 | 1.5-1.7 | 1.5-1.7 | 1.5-1.7 | 1.5-1.7 |
| Dot Matrix | Printable | Printable | Printable | Printable | Printable |
| Printer | | | | | |
| Laser | Printable | Printable | Printable | Printable | Printable |
| Printer | | | | | |
| Photocopier | Printable | Printable | Printable | Printable | Printable |

### Printing Tests

A. Thermal Transfer Printing Tests

Coated media are cut into two-inch width strips. Brady Thermal Transfer Printer Model 300X-Plus II or 600X-Plus II is used for the printing tests with a variety of Brady series thermal transfer ribbons. The media are printed with alphanumerics and 3:1 ratio barcodes with 0.006 inch×dimension bars. The suited Brady series thermal transfer ribbons include R4300 (black print with wax/resin formulation) at a burn temperature of 9-11; R4402B (blue print with resin formulation) at a burn temperature of 28-30; R4402G (green print with resin formulation) at a burn temperature of 28-30; R4402R (red print with resin formulation) at a burn temperature of 28-30; R4502B (blue print with wax/resin formulation) at a burn temperature of 11-14; R4502G (green print with wax/resin formulation) at a burn temperature of 11-14; R4502R (red print with wax/resin formulation) at a burn temperature of 11-14; R4800 (black print with resin formulation) at a burn temperature of 26-29; R4900 (black print with resin formulation) at a burn temperature of 26-28; R6000 (black print with resin formulation) at a burn temperature of 27-29; R6100 (black print with resin enhanced formulation) at a burn temperature of 9-11; R6200 (black print with resin formulation) at a burn temperature of 25-26; R6400 (black print with resin formulation) at a burn temperature of 27-29; and R6500 (black print with resin formulation) at a burn temperature of 28-30. All the media/ribbon combinations exhibit excellent printability with grade A or B barcode readability and pass ANSI barcode specification.

B. Inkjet Printing Tests

Coated media are cut into 8.5 by 11 inch sheets and fed into an Epson Stylus C88+ Inkjet Printer equipped with Epson aqueous DURABrite Ultra CMYK inks. The printer is set as plain paper, photo mode with ICM off (no color adjustments), high speed off, and edge smoothing off for printing a color block test page with CMYK blocks and blocks of five RAL standard sign colors (yellow, orange, red, green and blue). The color density of the inkjet printed color block test page with CMYK blocks and blocks of five RAL standard sign colors is measured as absolute reflected optical densities with a Gretag Macbeth D19C Densitometer. All coated media exhibit excellent printability with sharp color edge, superb color gamut and good imaging resolution. The matte finish media have an average optical density of the primary colors (CMYK) in the range of 1.1 to 1.3. The satin finish media have an average optical density of the primary colors (CMYK) in the range of 1.5 to 1.7.

C. Dot Matrix Printing Tests

Coated media are cut into 8.5 by 11 inch sheets and fed into a Brady SLV-DAT-PTR Dot Matrix Printer equipped with Brady series ribbon R5390 or R2080. Test pages are printed with text sizes varying from 8 to 24 points. The media/ribbon combination exhibit excellent printability with clear printed letter edge.

D. Laser Printing Tests

Coated media are cut into 8.5 by 11 inch sheets and fed into an HP P2035 office laser jet printer or a Lexmark T644 laser printer. Test pages are printed with text sizes varying from 8 to 24 points. The coated media exhibit excellent printability with clear letter edge.

E. Photocopier Printing Tests

Coated media are cut into 8.5 by 11 inch sheets and fed into a Konica Minolta Bizhub 350 office photocopier. Test pages are photocopied with text sizes varying from 8 to 24 points. The coated media exhibit excellent printability with clear letter edge.

### Adhesion Tests

Adhesion of the coated media and prints is tested with crosshatch adhesion tests. Crosshatch patterns consisting of six vertical lines and six horizontal lines are cut into the surface of the coated media using a razor blade. Any detached flakes resulting from the cutting of the coating are gently brushed away. The result is a 5 by 5 cell grid. Scotch adhesive tape #600 (more aggressive) or #810 is applied to the surface of the grid, smoothed down with a finger, and allowed to dwell about 10 seconds. The tape is then rapidly pulled off of the substrate by pulling normal to the surface. The test is graded by the amount of coating and ink that remain adhered to the substrate. The coated media exhibit excellent adhesion with 95 to 100 percent of the coating and ink remaining adhered to the substrate after tape removal.

### Abrasion Resistance Tests

Abrasion resistance of the coated media is tested using a Taber Abraser with CS-10 grinding wheels and 500 g/arm (Fed. Std. 191A, Method 5306) by abrading a printed large solid black color block of approximately 4 inches by 4 inches. Densitometer measurements of the optical density in the wear pattern are taken every 50 to 100 cycles until the color density decreases by 30%. The number of cycles at which the black density is 70% of the initial value is the endpoint. The coated media with inkjet prints exhibit superb abrasion resistance with more than 1,000 cycles to reach the endpoint.

### Gloss Tests

The surface gloss of the coated matte finish and satin finish media is measured using a Micro Tri-Gloss Meter made by BYK Gardner, Inc. with the standard procedures described in the instrument manual provided by the manufacturer. The surface gloss is measured on the sheets prior to printing. The Micro-Tri Gloss Meter is calibrated at sixty (60) degrees using the standard supplied by the unit. The sample is placed on a flat surface and the surface gloss is measured at sixty (60) degrees. The matte finish media have a gloss in the range of 2 to 3. The satin finish media have a gloss in the range of 15 to 25.

### Chemical/Solvent Resistance Tests

Chemical/solvent resistance of printing media or inks is performed as Solvent Dip and Rub Tests. Samples are subjected to five cycles of 10 minutes immersion in solvent followed by 30 minutes drying. After the last immersion, the sample is rubbed with a cotton swab immersed in the solvent 10 times. Observations are recorded after each immersion and the rub. Test solvents include de-ionized water methyl ethyl ketone, acetone, toluene, isopropanol, mineral spirits, gasoline, JP-8 jet fuel diesel fuel, brake fluid, Skydrol 500B-4, SAE 20 wt oil, ASTM #3 oil, MIL-H 5606 oil, Formula 409 cleaner, Northwoods Buzz Saw terpene degreaser, 3%, Alconox® solution, Super Agitene®, 10% sodium hydroxide, 10% sulfuric acid, etc. The coated media with inkjet prints exhibit superb chemical/solvent resistance with invisible change observed after the tests.

### Humidity Chamber Tests

Color block samples from inkjet printing are placed in a humidity chamber at 37° C. and 95% relative humidity. Samples are examined visually after 100, 360 and 720 hours for any bleeding or change in width of the black lines around the color blocks. The coated media with inkjet prints exhibit excellent humidity resistance with invisible change after 720 hours in the humidity chamber.

### Heat Aging Tests

Heat aging tests are conducted by placing inkjet printed color block samples of polyester and polyimide substrates in ovens of 80, 90, 100, 110, 120, 130, 145 and 160° C. for 720 hours. The yellow density of a white patch and the densities of CMYK patches are measured before and after the tests. The color block samples are also subjected to, 5 minute, short-term high service temperature tests at 180, 200 and 210° C. The coated matte finish and satin finish polyester and polyimide substrates with inkjet prints exhibit excellent heat aging resistance with invisible or minimal change after the tests.

### Accelerated Weathering Tests

Accelerated weathering tests are conducted by exposing samples in an Atlas Ci5000 Weather-O-Meter under ASTM G155 conditions. Blocks from the color block test page are adhered to an aluminum weathering panel with transfer adhesive. The panel is marked with a permanent marker for identification. Densitometer measurements of the optical density of the color patches and the yellow optical density of the unprinted white patches are taken initially and after approximately 24, 200, 200, 400, 600 and 800 hours of exposure or until failure with the color density decreases by 30%. The coated matte finish and satin finish media with inkjet prints exhibit excellent weatherability with minimal change after 800 hours of tests.

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. A formulation comprising:
A. A polyurethane binder,
B. An absorptive pigment,
C. A crosslinker,
D. An ultraviolet (UV) absorber,
E. A light stabilizer, and
F. Solvent.

2. The formulation of claim 1 comprising, based on the total weight of solids in the formulation:
A. 5 to 80 wt % polyurethane binder;
B. 10 to 80 wt % absorptive pigment;
C. 5 to 60 wt % crosslinker; and
D. 0.5 to 10 wt % combination of UV absorber and light stabilizer.

3. The formulation of claim 2 in which the polyurethane binder is a water-insoluble, water-dispersed, hydrophilic, crosslinkable aliphatic polyurethane dispersion.

4. The formulation of claim 3 in which the absorptive pigment is a hydrophilic, microporous, absorptive silica, alumina, boehmite, calcium carbonate, kaolin, clay, talc, titanium dioxide or zinc oxide with an average particle size of 1 to 25 microns.

5. The formulation of claim 4 in which the crosslinker is heat curable.

6. The formulation of claim 5 in which the UV absorber and light stabilizer are present in the combination at a weight ratio of 1:10 to 10:1.

7. The formulation of claim 6 in which the solvent comprises a mixture of de-ionized water and one or more alcohol, the mixture comprising at least 50 percent by weight of the alcohol.

8. A coated, plastic media comprising opposing facial surfaces, neither facial surface comprising a primer or having received a surface treatment prior to application of the coating, the coating comprising:
A. A polyurethane binder,
B. An absorptive pigment,
C. A crosslinker,
D. An ultraviolet (UV) absorber,
E. A light stabilizer, and
F. Solvent.

9. The coated, plastic media of claim 8 in which the formulation comprises:
A. 5 to 80 wt % polyurethane binder;
B. 10 to 80 wt % absorptive pigment;
C. 5 to 60 wt % crosslinker; and
D. 0.5 to 10 wt % combination of UV absorber and light stabilizer.

10. The coated, plastic media of claim 9 in which the polyurethane binder is a water-insoluble, water-dispersed, hydrophilic, crosslinkable aliphatic polyurethane dispersion.

11. The coated, plastic media of claim 10 in which the absorptive pigment is a hydrophilic, microporous, absorptive silica alumina, boehmite, calcium carbonate, kaolin, clay, talc, titanium dioxide or zinc oxide with an average particle size of 1 to 25 microns.

12. The coated, plastic media of claim 11 in which the crosslinker is heat curable.

13. The coated, plastic media of claim 12 in which the UV absorber and light stabilizer are present in the combination at a weight ratio of 1:10 to 10:1.

14. The coated, plastic media of claim 13 in which the solvent comprises a mixture of de-ionized water and one or more alcohol, the mixture comprising at least 50 percent by weight of the alcohol.

15. The coated, plastic media of claim 14 in which coating has a thickness of 5 to 200 microns.

16. The coated, plastic media of claim 15 in which the media is a film or cloth comprising at least one of polyester, vinyl, nylon, polyolefin and polyimide.

17. The coated, plastic media of claim 16 in which the coating further comprises print received from at least one of a thermal transfer printer, inkjet printer, dot matrix printer, laser printer or photocopier.

18. A formulation comprising:
A. A polyurethane binder,
B. A submicron-sized pigment,
C. An ultraviolet (UV) absorber,
D. A light stabilizer,
E. A leveling/flow agent, and
F. Water.

19. The formulation of claim 18 in which the submicron-sized pigment and polyurethane binder are present at a pigment to binder weight ratio of 0.8:1 to 2:1.

20. The formulation of claim 19 in which the UV absorber and light stabilizer are present at an absorber to stabilizer weight ratio of 1:10 to 10:1, and the water is de-ionized water.
